(19) United States
(12) Patent Application Publication
(10) Pub. No.: US 2005/0203232 A1
(43) Pub. Date: Sep. 15, 2005

(54) Ethylene copolymer modified oriented polypropylene

(76) Inventors: Loic Pierre Rolland, Divonne Les Bains (FR); Sam Louis Samuels, Landenberg, PA (US); Hwee Tatz Thai, Singapore (SG)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/072,383

(22) Filed: Mar. 4, 2005

Related U.S. Application Data
(60) Provisional application No. 60/550,721, filed on Mar. 5, 2004.

(51) Int. Cl. C08K 3/26

(52) U.S. Cl. 524/425

(57) ABSTRACT

Disclosed are oriented films, tapes, and melt-spun fibers prepared from compositions comprising (a) at least one polypropylene polymer; and (b) at least one ethylene copolymer such as ethylene/vinyl acetate dipolymers, ethylene/vinyl acetate terpolymers, ethylene/alkyl (meth)acrylate dipolymers, ethylene/alkyl (meth)acrylate terpolymers, functionalized ethylene copolymers, ethylene/acid copolymers, and salts thereof. The films, tapes and fibers exhibit improved tensile properties such as tensile strength and elongation at break compared to nonmodified polypropylene compositions. Also disclosed are woven, nonwoven and knitted textiles prepared from the oriented melt-spun fibers described, and methods for producing slit film fibers of the invention.

This application claims the benefit of U.S. provisional application Ser. No. 60/550,721, filed Mar. 5, 2004, the entire disclosure of which is incorporated herein by reference.

This invention relates to films, tapes and fibers, which may optionally be oriented, comprising a polypropylene and an ethylene copolymer, to woven, nonwoven and knitted textiles prepared from the fibers, and to methods for preparing the films, tapes, and fibers of the invention.

### BACKGROUND OF THE INVENTION

All references disclosed herein are incorporated by reference in their entirety.

Oriented films comprising polypropylene may be formed from the molten polymer by a number of methods known in the art. For example, in cast film extrusion, flat films can be extruded into a cooling water bath or onto chilled rolls for quenching. Alternatively, in blown film extrusion a tubular blown film can be extruded through an annular die and air-quenched. Films can be oriented in one direction by hot-drawing with a tensioning device, and annealing. Films can also be oriented in two directions (machine direction and transverse direction) by suitable tensioning devices. Oriented polypropylene films are useful for a wide variety of packaging applications.

Also, tapes may be prepared from extruded polypropylene films by slitting them, with knives for example, after quenching and before or after orienting the film. The tapes may then be stretched (i.e. uniaxially oriented) to several times their original length by hot-drawing in the machine direction with a tensioning device and annealing the stretched tapes. The tapes may have controlled widths (for example from about 2.5 mm to about 6 mm). Polypropylene tapes can be used in a number of applications. For example, tapes can be coated with a variety of appropriate adhesives to prepare adhesive tapes.

Fibers comprising polypropylenes may be formed directly from the molten polymer by a number of methods known in the art, including melt-spinning, centrifugal spinning and melt-blowing. These methods typically produce fibers that are at least partially oriented.

Melt spun fibers can be incorporated into nonwoven textiles by many technologies, including dry laid, wet laid, air laid, spunbond, spunlace, and needlepunch processes. The nonwovens so produced can be used in a wide range of applications including apparel, carpet backing, agrotextiles and geotextiles.

Polypropylene fibers can be used in twines or ropes or to prepare yarns for carpets. Polypropylene yarns also can be woven or knitted into fabrics used in applications such as tarpaulins, liners, banners, sacking, carpet backing, agrotextiles and geotextiles.

To conserve material, and therefore to conserve cost, it is desirable to reduce the denier of tapes and fibers and the thickness of films, typically by increasing the stretch ratio. With conventional polypropylene compositions, however, higher stretch ratios and reduced denier can result in unacceptable degradation of physical properties such as tensile breaking load, tenacity (tensile breaking stress) and elongation at break. Undesirable fibrillation of polypropylene tapes under high stretch ratios must also be overcome.

Polypropylene fibers with improved mechanical properties have been prepared by adding small amounts of additives to polypropylene. See, e.g., PCT Patent Application WO 2003/048434, EP0080274B1, and Journal of Applied Polymer Science, 1986, 31(8), 2753-68.

It remains desirable, however, to improve the mechanical properties such as tensile breaking load, tenacity and elongation to break of polypropylene compositions used in films, melt-spun fibers and slit-film tapes; to improve or maintain the elastic properties of polypropylene polymer formulations loaded with higher levels of inert fillers such as CaCO₃ without loss of tensile properties; to improve the physical properties of polypropylene formulations processed by cooling a cast film (before slitting) on a chilled roll; to improve “low speed” perforation and “high speed” perforation; and to increase the width of the tape (with similar thickness) and reduce the construction of the woven fabric by reducing the number of tapes per dimension (e.g., to progress from a construction comprising 8×8 tapes/in² to a construction comprising 5×5 tapes/in²).

### SUMMARY OF THE INVENTION

This invention provides a film comprising or prepared from a composition comprising (a) at least one polypropylene polymer and (b) from 0.1 to 30 weight % of at least one E/X/Y copolymer.

The film is prepared by drawing at a temperature below the melting point of the polypropylene at draw ratios of equal to or greater than 3.

This invention also provides a slit film tape prepared from the film.

This invention also provides a fiber prepared by hot-drawing and, optionally, annealing said slit film tape prepared from said film.

This invention further provides an oriented melt-spun fiber comprising or prepared from a composition comprising (a) at least one polypropylene polymer and (b) from 0.1 to 15 weight % of at least one E/X/Y copolymer. The fiber can be prepared by drawing at a temperature below the melting point of the polypropylene at draw ratios of equal to or greater than 3.

This invention also provides woven, nonwoven, and knitted textiles prepared from melt-spun fibers as described above.

This invention also provides films, slit film tapes, fibers (e.g. slit film fibers or melt-spun fibers) and nonwoven textiles wherein the composition described above further comprises (c) from 0.01 to 40 weight % of at least one additional component selected from the group consisting of fillers, delustrants, UV stabilizers, pigments and other additives.

This invention also provides processes for preparing slit film fibers comprising

(1) preparing a composition comprising (a) at least one polypropylene polymer; (b) from 0.1 to 30 weight % of at least one E/X/Y copolymer; and optionally (c) from 0.01 to 40 weight % of at least one additional component or additive;

(2) forming said composition into a film;

(3) slitting said film into tapes; and

(4) hot-drawing and, optionally, annealing a tape of step (3).

The polypropylene polymer can be one or more polypropylene homopolymers; random copolymers or block copolymers of polypropylene and ethylene; or random terpolymers or block terpolymers of polypropylene, ethylene and one other olefin. In the E/X/Y copolymer, E comprises ethylene; X is a monomer selected from the group consisting of vinyl acetate and alkyl (meth)acrylic esters; and Y is one or more comonomers including carbon monoxide; sulfur dioxide; acrylonitrile; maleic anhydride; maleic acid diesters; (meth)acrylic acid, maleic acid, maleic acid monoesters, itaconic acid, fumaric acid, fumaric acid monoester, and salts thereof; glycidyl acrylate, glycidyl methacrylate, and glycidyl vinyl ether; X is from 0 to 50 weight % of said E/X/Y copolymer, Y is from 0 to 35 weight % of said E/X/Y copolymer, wherein the weight % of X and Y cannot both be 0, and E being the remainder; provided that when X is an alkyl (meth)acrylate, the weight % of Y is other than 0. The additional component or additive can be one or more additive fillers, delustrants, UV stabilizers, pigments, or other additives.

### DETAILED DESCRIPTION OF THE INVENTION

The invention relates to enhancing the mechanical properties such as tensile breaking load, tensile modulus, tenacity (tensile breaking stress) and elongation at break (%) of stretched polypropylene films and tapes and enhancement of tenacity and elongation at break (%) of melt spun polypropylene fibers. One or more of these enhancements may be achieved by incorporating a small percentage (from about 0.1 to about 30, or about 1 to about 15, weight %) of an ethylene copolymer such as ethylene/vinyl acetate dipolymers, ethylene/vinyl acetate terpolymers, ethylene/alkyl (meth)acrylate dipolymers, ethylene/alkyl (meth)acrylate terpolymers, functionalized ethylene copolymers, ethylene/acid copolymers, and salts thereof into the polypropylene formulations used to prepare the films and fibers (the polypropylene formulations may optionally contain other materials selected from fillers such as CaCO₃ and additives such as UV stabilizers, pigments etc.). Blending an ethylene copolymer with a polypropylene also improves the processability of the polypropylene resin by, for example, increasing the melt strength of the molten polypropylene resin. The blends also may provide improved stretchability for films and fibers over conventional polypropylene films and fibers.

The modified polypropylene blends can also provide cost reduction by allowing production of finer denier polypropylene fibers having the same performance level as unmodified fibers at the same equipment throughput. Alternatively, higher throughput may be achieved at the same denier with improved performance. The blends may also provide lower production downtime for most processes, resulting from fewer strand and web breaks.

The drawability of tapes prepared from these blends can also be improved during manufacturing. For example, the blends allow increased draw ratios with no or reduced tape fibrillation. Moreover, the physical properties of polypropylene formulations processed by cooling a cast film (before slitting) on a chilled roll may be less favorable than are those of formulations processed by using a chilled water bath. The stretchability of a film cooled on a chilled roll is poor, because the slower cooling results in a more crystalline film. The incorporation of ethylene copolymers usually enhances the stretchability of the films and overcomes or reduces the fibrillation of the slit film tapes prepared from such films in subsequent drawing. Incorporation of ethylene copolymers may also improve continuity and/or reduce breaks in processing oriented films. It may also provide a reduction in energy consumption during processing, reducing extruder torque. It may also enhance the drawability of melt-spun fibers and enhances the tensile properties of the drawn fibers.

Polypropylene (PP) polymers include homopolymers, random copolymers, block copolymers and terpolymers of propylene. Copolymers of propylene include copolymers of propylene with other olefins such as ethylene, 1-butene, 2-butene and the various pentene isomers, etc. and preferably copolymers of propylene with ethylene. Terpolymers of propylene include copolymers of propylene with ethylene and one other olefin. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene. Although these polypropylenes described above are the preferred polypropylenes, other polypropylenes are not excluded. The term “polypropylene” when used herein is used generically to refer to any or all of the polymers comprising propylene.

Polypropylene homopolymers or random copolymers can be manufactured by any known process. For example, PP polymers can be prepared in the presence of Ziegler-Natta catalyst systems, based on organometallic compounds and on solids containing titanium trichloride.

Block copolymers can be manufactured similarly, except that propylene is generally first polymerized by itself in a first stage and propylene and additional comonomers such as ethylene are then polymerized, in a second stage, in the presence of the polymer obtained during the first. Each of these stages can be carried out, for example, in suspension in a hydrocarbon diluent, in suspension in liquid propylene, or else in gaseous phase, continuously or noncontinuously, in the same reactor or in separate reactors.

Additional information relating to block copolymers and to their manufacture may be found particularly in chapters 4.4 and 4.7 of the work “Block Copolymers” edited by D. C. Allport and W. H. Janes, published by Applied Science Publishers Ltd in 1973.

Suitable ethylene copolymers E/X/Y copolymers wherein E comprises ethylene, X is a comonomer selected from the group consisting of vinyl acetate and alkyl (meth)acrylic acid esters; and Y comprises one or more additional comonomers such as, e.g., carbon monoxide; sulfur dioxide; acrylonitrile; maleic anhydride; maleic acid diesters; (meth)acrylic acid, maleic acid, maleic acid monoesters, itaconic acid, fumaric acid, fumaric acid monoesters, and salts thereof; glycidyl acrylate, glycidyl methacrylate, and glycidyl vinyl ether.

In this connection, the term “(meth)acrylic acid,” and the abbreviation “(M)AA,” refers to methacrylic acid and/or acrylic acid. Likewise, the terms “(meth)acrylate” and “alkyl (meth)acrylate” refer to esters of methacrylic acid and/or acrylic acid.

Of note are ethylene/vinyl acetate dipolymers, ethylene/vinyl acetate terpolymers, ethylene/alkyl (meth)acrylate terpolymers, functionalized ethylene copolymers, ethylene/acid copolymers, and salts thereof.

In general, the amount of X may range up to about 50 weight %, and is preferably less than or equal to 40 weight %, based on the total weight of the E/X/Y copolymer. The amount of Y may range up to about 35 weight %, based on the total weight of the E/X/Y copolymer. The total amount of X and Y may not be equal to 0. In other words, the ethylene copolymer must contain a finite amount of X and/or Y.

When X comprises an alkyl (meth)acrylic acid ester, the alkyl group is a C₁₋₁₀, or C₁₋₈, or C₁₋₆, branched or unbranched, saturated hydrocarbyl group. The alkyl group in the alkyl (meth)acrylate comonomer may also have from 1 to 4 carbon atoms. Examples of alkyl (meth)acrylates include methyl acrylate, ethyl acrylate and butyl acrylate. Methyl group is frequently used.

The alkyl (meth)acrylate comonomer may have a concentration range of from 5 to 35, or 10 to 30, or 10 to 25, weight % of the ethylene copolymer. Of note are ethylene alkyl acrylate copolymers comprising 25 weight % of alkyl acrylate, based on the weight of the ethylene copolymer.

In certain embodiments of the invention, the amount of Y is zero. In other embodiments of note, the amount of X is zero. Moreover, when X is an alkyl (meth)acrylate, the Y comonomer is present in a finite amount, that is, the weight % of Y is not equal to 0.

The relative amount and choice of the X and Y comonomers present in the ethylene copolymer can be viewed as contributing to how and to what degree the resulting copolymer is to be viewed as a polar polymeric constituent in the thermoplastic composition.

Suitable Y components include, without limitation, comonomers selected from the group consisting of carbon monoxide, sulfur dioxide, and acrylonitrile. Of note are E/X/Y terpolymers such as ethylene/methyl acrylate/carbon monoxide (E/MA/CO), ethylene/ethyl acrylate/carbon monoxide (E/EA/CO) and ethylene/n-butyl acrylate/carbon monoxide (E/n-BA/CO), and ethylene/vinyl acetate/carbon monoxide (ENA/CO).

Other suitable Y components include (meth)acrylic acid. Of note are ethylene/acid copolymers including E/(M)AA dipolymers having from about 2 to about 30 weight % (M)M. These copolymers can be defined in the context of this invention as an E/X/Y copolymer wherein the weight % of X is 0 and Y is (meth)acrylic acid with a weight % of from about 2 to about 30 weight %, the remainder being ethylene.

In certain embodiments, the ethylene copolymer is an E/X/Y terpolymer wherein E is ethylene, X is selected from the group consisting of C₁ to C₈ alkyl (meth)acrylate esters and Y is (meth)acrylic acid. Suitable ethylene/acid terpolymers include ethylene/n-butyl (meth)acrylate/(meth)acrylic acid terpolymers, ethylene /iso-butyl (meth)acrylate/(meth)acrylic acid terpolymers, ethylene/methyl (meth)acrylate/(meth)acrylic acid terpolymers, and ethylene/ethyl (meth)acrylate/(meth)acrylic acid terpolymers.

Ethylene/acid copolymers may be at least partially neutralized into salt form. At least one cation, such as an alkali metal, transition metal, or alkaline earth metal cation, preferably lithium, sodium, potassium, magnesium, calcium, or zinc, or a combination of these cations, is used to neutralize some portion of the acidic groups in the copolymer. These neutralized acid copolymers are commonly referred to as ionomeric resins (“ionomers”). Preferably at least 30%, or at least 45%, or at least 50%, or at least 60%, of the available acid moieties are neutralized.

Ionomers useful in this invention include those prepared from E/(M)AA dipolymers having from about 2 to about 30 weight % (M)AA. Of note as component (b) of the compositions used in this invention are ethylene copolymers wherein Y is selected from the group consisting of acrylic acid and methacrylic acid; and salts thereof. Various ionomeric resins are sold by E. I. du Pont de Nemours and Company (DuPont), Wilmington, Del. under the trademark Surlyn® and by the Exxon Corporation under the tradenames “Escor” and “lotek.”

Also suitable as Y components in the E/X/Y copolymers are functionalizing comonomers than can be used to produce functionalized ethylene copolymers. The term “functionalized ethylene copolymers” as used herein denotes copolymers of ethylene that incorporate reactive functional groups such as anhydrides and epoxides that can react with other components by, for example, covalent bonding.

Accordingly, suitable functionalizing comonomers Y include, for example, maleic anhydride and maleic diesters or monoesters (maleic half-esters) including esters of C₁-C₄ alcohols, such as, for example, methyl, ethyl, n-propyl, isopropyl, and n-butyl alcohols. Of note is an ethylene/maleate copolymer that includes maleic anhydride. Also of note is an ethylene/maleate copolymer that includes maleic acid monoesters. When the ethylene copolymer includes residues of maleic acid or the monoester of maleic acid, these moieties may be neutralized to their salt form. The preferred ions and neutralization levels are as described above for ionomers. Some functionalized copolymers of note are available commercially from DuPont under the trademark Surlyn®.

Maleated ethylene copolymers (maleated polyethylene) may be synthesized by grafting. Grafted E/X/Y copolymers as described herein include copolymers wherein a portion of the E component comprises an alpha-olefin other than ethylene, such as butene, hexene or octane, to modify the density of the copolymer. An example of a grafted maleic anhydride modified linear high-density polyethylene is a product sold under the trademark Polybond® 3009 available from Crompton Corporation. Similar maleated polyolefins are sold under the trademark Fusabond® available from DuPont. Typical grafted E/X/Y copolymers are those wherein maleic anhydride is incorporated in a range from about 0.3 to about 2 weight % based on the total weight of the ethylene copolymer.

Ethylene copolymers that include reactive functional groups such as maleic anhydride can also be readily obtained by a high-pressure free radical process. A high-pressure process suitable for use in preparing such copolymers is described, for example, in U.S. Pat. No. 4,351,931. This eliminates the secondary process step of grafting traditionally used to create maleic anhydride-functionalized polymers. In addition, it is easier to obtain maleic anhydride incorporation to levels greater than 2 weight % using this process than by grafting. More specifically, copolymers prepared from ethylene and a functional comonomer prepared by this process can comprise from about 3 weight % to about 15 weight % of the functional comonomer. Of note are copolymers such as ethylene/maleic anhydride (E/MAH), ethylene/ethyl hydrogen maleate (also known as ethylene/maleic acid monoester, or E/MAME) copolymer, and E/MMA/MAME copolymers, which are synthesized directly in high-pressure autoclaves.

Also suitable as Y components in the E/X/Y copolymers useful in this invention are epoxy-functionalized comonomers such as glycidyl acrylate, glycidyl methacrylate, or glycidyl vinyl ether (i.e. comonomers containing moieties derived from 2,3-epoxy-1-propanol).

Epoxy-functionalized copolymers may be represented by the formula: E/X/Y, where E is the copolymer unit —(CH₂CH₂)— derived from ethylene; X is the copolymer unit —(CH₂CR¹R²)—, where R¹ is hydrogen or methyl, and R² is carboalkoxy of 1 to 10 carbon atoms (X for example is derived from alkyl acrylates, alkyl methacrylates) or acetyloxy; and Y is the copolymer unit —(CH₂CR³R⁴)—, where R³ is hydrogen or methyl and R⁴ is carboglycidoxy or glycidoxy (Y for example is derived from glycidyl acrylate, glycidyl methacrylate, or glycidyl vinyl ether).

Preferred, E/X/Y copolymers are those wherein X is 5 to 50 weight % of said E/X/Y copolymer, Y is 0.3 to 15 weight % of said E/X/Y copolymer, E being the remainder.

The comonomer containing the glycidyl moiety (e.g., glycidyl acrylate or glycidyl methacrylate) is about 0.3 (or about 0.5) weight % to about 8 (or about 10) weight % and the alkyl acrylate is from about 5 to about 40 (or from about 20 to about 40, or from about 25 to about 35) weight % of the epoxy-functionalized ethylene copolymer.

Of note are copolymers such as ethylene/methyl acrylate/glycidyl methacrylate (E/MA/GMA), ethylene/ethyl acrylate/glycidyl methacrylate (E/EA/GMA) and ethylene/n-butyl acrylate/glycidyl methacrylate (E/n-BA/GMA).

It is also preferred that the epoxide-containing monomers, and more preferably the glycidyl-containing monomers, are incorporated into the reactant copolymer by the concurrent reaction of monomers and are not grafted onto a polymer by graft polymerization.

The specific selection of the grade of ethylene copolymer may depend on melt indices of the modifier and the polypropylene, the draw temperature of the formulated blend relative to the respective softening points of the ethylene copolymer and the polypropylene, or the draw profile (draw rate and draw ratio) that is desired. Other factors include increased elastic recovery associated with higher relative molecular weight copolymer and the pragmatic ability of a relatively lower molecular weight copolymer to more easily blend with fillers.

The compositions useful in this invention may optionally further comprise fillers such as CaCO₃, and other additives such as delustrants such as TiO₂, thermal and ultraviolet (UV) stabilizers, UV absorbers, antistatic agents, terminating agents, fluorescent whitening agents, pigments, or other additives that are conventional in the art of polypropylene films and melt spun fibers. These conventional ingredients may be present in the compositions in quantities that are generally from 0.01 to 40 weight %, 0.01 to 20 weight %, or 0.1 to 15 weight %.

The optional incorporation of such conventional ingredients into the compositions comprising polypropylene and ethylene copolymer can be carried out by any known process. This incorporation can be carried out, for example, by dry blending, by extruding a mixture of the various constituents, by the conventional masterbatch technique, adding a concentrate of the additive, adding the additive such as a filler mixed in a polymeric carrier, or the like. A typical masterbatch may comprise from 75 to 90 weight % of CaCO₃. Of note is the use of a masterbatch comprising CaCO₃ and the ethylene copolymer. Further information about suitable levels of additives and methods of incorporating them into polymer compositions may be found in standard reference texts.

The mechanical properties such as tenacity, tensile breaking load, elongation at break and denier of the films, tapes and fibers of this invention can be balanced by adjusting various parameters including
resin formulation design (base resin, level and types of additives such as CaCO₃, UV stabilizers, pigment added);
amount and type of ethylene copolymer used;
processing equipment (quenching, slitting, drawing and annealing configuration); and
processing conditions (extruder screw configuration, temperature profile and polymer throughput, stretch and annealing temperatures and profiles, line speed, etc).

Typically, a manufacturing facility for preparing films or fibers will have a limited ability to modify equipment and processing conditions. Therefore, ethylene copolymer modification of the polypropylene resin as described herein can provide significant improvement in mechanical properties of the polypropylene films, tapes and fibers prepared without introducing retooling costs.

The thermoplastic compositions are suitable for preparation of films by any means of processing that is suitable for thermoplastic compositions. Extrusion processing is the most typical method. The films are useful in a wide variety of packaging applications, including shrink film, and for preparing slit film tapes.

A film can be either a single layer or multilayer polymeric film. The multilayered films comprise more than one layer including, for example, tie layers, which may or may not include the polypropylene and ethylene copolymer that define the films and fibers of the invention, provided that the presence of the other layers does not negate the favorable properties of the layer or layers comprising the polypropylene and ethylene copolymer. Methods of forming multilayered film structures, by casting or coextrusion, e.g., are well known in the art. Various additives as generally practiced in the art can be present in any layer or layers of the multilayered film structures, again provided that their presence does not negate the properties of the film of the invention. Thus, it is contemplated that various additives such as antioxidants and thermal stabilizers, ultraviolet (UV) light stabilizers, pigments and dyes, fillers, delustrants, anti-slip agents, plasticizers, other processing aids, and the like may be advantageously employed.

Films can be made by virtually any method of extrusion processing known to those skilled in this art. For example, a primary film may be manufactured by extruding the said compositions using so-called “blown film” or “flat die” methods. A blown film is prepared by extruding the polymeric composition through an annular die and expanding the resulting tubular film with an air current to provide a blown film. Cast flat films are prepared by extruding the composition through a flat die. The film leaving the die is cooled by at least one roll containing internally circulating fluid (a chill roll) or by a water bath to provide a cast film. A film of this invention would have a width, for example, of about 60 cm (two feet).

A film can be further oriented beyond the immediate quenching or casting of the film. The process comprises the steps of extruding a laminar flow of molten polymer, quenching the extrudate and orienting the quenched extrudate in at least one direction. “Quenched” describes an extrudate that has been substantially cooled below its melting point in order to obtain a solid film material.

The film may be uniaxially oriented, or biaxially oriented by drawing in two mutually perpendicular directions in the plane of the film to achieve a satisfactory combination of mechanical and physical properties. Films may be drawn at temperatures below the melting point of the neat polypropylene. The drawing ratio may generally be about 2:1 or greater, about 3:1 or greater, about 4:1 or greater, or about 6:1 or greater. The draw ratio may be in the range of 3:1 to about 16:1 and a typical drawing ratio for some compositions may be from about 4:1 to about 10:1.

Those skilled in the art are aware that, in general, the maximum possible draw ratio cannot be reached along both axes, when orienting a film biaxially. Accordingly, the draw ratio of a biaxially oriented film is defined herein as the product of the draw ratio along each axis.

Orientation and stretching apparatus to uniaxially or biaxially stretch film are known in the art and may be adapted by those skilled in the art to produce films of the present invention. Examples of such apparatus and processes include, for example, those disclosed in U.S. Pat. Nos. 3,278,663; 3,337,665; 3,456,044; 4,590,106; 4,760,116; 4,769,421; 4,797,235 and 4,886,634.

A blown film of the present invention may be oriented using a double bubble extrusion process, where simultaneous biaxial orientation may be effected by extruding a primary tube which is subsequently quenched, reheated and then expanded by internal gas pressure to induce transverse orientation, and drawn by differential speed nip or conveying rollers at a rate which will induce longitudinal orientation.

The processing to obtain an oriented blown film is known in the art as a double bubble technique, and can be carried out as disclosed in U.S. Pat. No. 3,456,044. A primary tube may be melt extruded from an annular die. This extruded primary tube is cooled quickly to minimize crystallization. It is then heated to its orientation temperature (for example, by means of a water bath). In the orientation zone of the film fabrication unit a secondary tube is formed by inflation, thereby the film is radially expanded in the transverse direction and pulled or stretched in the machine direction at a temperature such that expansion occurs in both directions, preferably simultaneously; the expansion of the tubing being accompanied by a sharp, sudden reduction of thickness at the draw point. The tubular film is then again flattened through nip rolls. The film can be reinflated and passed through an annealing step (thermofixation), during which step it is heated once more to adjust the shrink properties.

The film may be formed by an extrusion process that causes the polymer chains in the film to be generally aligned in the direction of extrusion. Linear polymers, after being highly oriented uniaxially possess considerable strength in the orientation direction, but less strength in the transverse direction. This alignment can add strength to the film in the direction of extrusion, which corresponds to the length dimension of the slit film yarns. Alternatively, the film may be formed through a blowing process known to those skilled in this art.

Slit film tapes can be prepared from films disclosed herein. Tapes can be those prepared from the preferred films above. The film may be drawn after quenching and prior to slitting. Preferably, however, a primary nonoriented film is slit into tapes that are drawn before being reeled up. The slit film tapes can be produced with a slitting apparatus that comprises a support frame; a plurality of substantially planar cutting blades, each of which includes opposed cutting edges and opposed ends; a mounting structure for mounting the cutting blades to the support frame; and a feed roll attached to the support frame and configured to feed film in a downstream direction over the exposed cutting edges of the blades. The mounting structure is configured to mount the cutting blades in substantially aligned, parallel and spaced apart relationship, wherein the blades are mounted such that each blade has one of its cutting edges exposed for cutting, and wherein the cutting edges of adjacent blades are spaced apart from each other.

After slitting the film into tapes as described above, the drawing operation would be done over a span of from 3 to 6 meters (ten to twenty feet) in an oven heated to a temperature effective to soften the film so as to facilitate the drawing operation. What typically takes place is that the film is cold at the beginning of the path through the oven and is progressively heated and softened as it passes through the oven. Necking takes place at a neckline that is at a certain distance from the entrance to the oven. The location of the necking zone depends on a number of factors including the rate of stretching, the temperature of the oven, and the nature and thickness of the film material. A typical pre-stretched tape may have, for example, a thickness about 120 microns (μ) and a width of about 6 cm to about 8 cm. After stretching, the final tape has a thickness of about 30 to 50μ and a width of about 2.5 cm to about 3 cm. Tapes can be made wider or narrower for certain purposes. For example, fibers for reduced end count woven fabric can have a final width of from about 4 mm to about 6 mm; polypropylene strapping can have a final width of about 10 mm to 15 mm.

Tapes may be drawn at temperatures below the melting point of the neat polypropylene. The oriented fibers that result from drawing a slit film tape are referred to herein as “slit film fibers”.

The drawing ratio will generally be about 2:1 or greater, about 3:1 or greater, about 4:1 or greater, or about 6:1 or greater. The draw ratio may be in the range of about 3:1 to about 16:1 and a typical drawing ratio for some compositions may be from about 4:1 to about 10:1. The drawing ratio for woven tape is preferably from about 5:1 to about 8:1. The drawing ratio for wider strapping tape is typically from about 10:1 to about 15:1. After hot-drawing, the resulting monofilament fibers for woven tape would typically have a denier of from about 700 to about 1700. Polypropylene strapping can have a denier of from about 3000 to about 6000. The distance over which longitudinal drawing takes place will vary with the technique used. In the short-draw the stretching takes place over a distance of a few inches, other techniques involve much greater distances.

Fibers may also be prepared directly from extrusion processes including centrifugal spinning, melt-spinning, spunbonding, or melt-blowing.

In centrifugal spinning, fibers are formed as a polymer melt is accelerated from a rapidly rotating source. Molten material from a furnace is transferred into a rotating spinner, and the fibers are produced as centrifugal force extrudes the material through small holes in the side of the spinning device.

In melt spinning, the fiber-forming substance is melted for extrusion through a spinneret and then directly solidified by cooling. Melt spun fibers can be extruded from the spinneret in different cross-sectional shapes (round, trilobal, pentalobal, octalobal, and others). In-line drawing is effected by wrapping the moving threadline around sets of rotating rolls running at controlled temperature and speeds. Depending on the specific melt spinning process and subsequent processing steps, product can be collected as monofilaments, yarn, tow or nonwoven (e.g. spunbond). See Fibers from Synthetic Polymers, Rowland Hill, ed., Elsevier Publishing Co., NY, 1953 for a general reference regarding melt spun fibers.

Spunbonding is the direct laydown of nonwoven textile webs from fibers as they are melt-spun. Continuous filaments are extruded through a spinneret, accelerated (via rolls or jets) and laid down onto a moving belt to form a nonwoven sheet. Bonding occurs at molten fiber crossover points.

Meltblowing is another direct laydown process in which fibers are extruded through a die tip, attenuated (and fractured) by hot, high velocity air, and deposited onto a moving belt or screen to form a textile web of fine (low denier) fibers.

Both spunbond (S) and meltblown (M) textile webs, after being formed, can be further bonded and/or patterned by calendering. Multiple layered nonwovens (e.g. SMS, SMMS, SMMMS) can also be prepared from fibers of this invention.

Fibers prepared as described herein, including slit tape fibers, are useful for preparing cords, twines or ropes. A number of fibers are joined together by, for example, twisting, braiding, interlacing and the like to form a cord. Twines, in general, contain a lower number of fibers and are smaller in diameter than ropes. These cords, twines or ropes may be roughly circular or flattened in cross section. Cords and twines can be used for shoelaces, straps for bags, briefcases and the like, and can be used in packaging applications. Ropes can be used in a wide variety of industrial and marine applications. Cords, twines and ropes may also be further interlaced (such as by knitting) to prepare nets having a relatively open structure, such as fishing nets, cargo nets and the like.

Slit tape fibers of this invention can be used as monofilament fibers for carpet tufting, synthetic lawns, matting and the like. They can also be used as strapping. When an adhesive is applied they can be used as adhesive tapes for uses such as strapping, in furniture or bonding materials together.

Woven or knitted textiles can be prepared from the slit tape fibers or melt-spun fibers as described above. In general, woven fabrics may have a tighter construction than knitted fabrics. Polypropylene yarns prepared as described herein can be woven into fabrics used in applications such as filters, tarpaulins, sails, boat tops, covers, awnings, tents, escape slides, canopies, banners, construction (e.g. roofing) membranes, machine belts, liners for luggage or packaging, heavy duty sacking, carpet backing, book covers, footwear, upholstery for use in home furniture, motor vehicles, boats, aircraft and the like, apparel, agrotextiles (for use in seed control, weed control, gardening, greenhouses and silage) and geotextiles (for erosion control and soil conservation). Knitted fabrics can be used for sacking for use in carrying bulky materials such as groceries, firewood and the like; and construction and industrial netting.

Woven fabrics according to the invention have a lower slip tendency, which is particularly useful in fabricating heavy-duty sacks.

For carpet backings, the shrink of the textile is important (for example, shrinkage less than 2.5% at 45° C. is desirable). Woven carpet backings are typically used as a primary backing for carpets to provide strength, dimensional stability and form to the carpet. They can be prepared from slit tape fibers of this invention.

Secondary carpet backings can be used to provide a substrate to which the carpet yarns are secured. They can be prepared from nonwoven materials. Melt spun fibers of this invention are useful for preparing nonwoven substrates useful as secondary carpet backing.

Nonwoven fabrics of this invention can be used in medical apparel such as hats, gowns, booties, and personal protective equipment including masks and the like, hygiene protective furnishings such as drapes, covers, blankets and the like, packaging, durable paper, wipes, wraps, banners, geotextiles, agrotextiles, upholstery, apparel, filters, liners, construction wrap for heat and moisture control in buildings, or roofing membranes.

Geotextiles are used in roads under the gravel and paving layers to improve road quality. Geotextile fabrics are typically manufactured by weaving polypropylene tapes having approximately 2.5 mm width. Geotextiles are also prepared from spunbonded nonwoven material derived from melt-spun fibers. Shrinkage requirements for geotextiles are not as stringent as those for carpet backings. However, resistance to perforation can be desirable for geotextiles.

1. An oriented film comprising or prepared from a composition comprising (a) at least one polypropylene polymer and (b) from 0.1 to 30 weight % of at least one E/X/Y copolymer wherein
The polypropylene polymer includes one or more polypropylene homopolymers; random copolymers or block copolymers of polypropylene and ethylene; or random terpolymers or block terpolymers of polypropylene, ethylene and one other olefin;
E comprises ethylene; X is a monomer selected from the group consisting of vinyl acetate and alkyl (meth) acrylic esters; and Y is one or more additional comonomers including carbon monoxide, sulfur dioxide, acrylonitrile, maleic anhydride, maleic acid diesters, (meth) acrylic acid, maleic acid, maleic acid monoesters, itaconic acid, fumaric acid, fumaric acid monoester, and salts thereof, glycidyl acrylate, glycidyl methacrylate, or glycidyl vinyl ether; and
X is from 0 to 50 weight % of said E/X/Y copolymer, Y is from 0 to 35 weight % of said E/X/Y copolymer, wherein the weight % of X and Y cannot both be 0, and E being the remainder; provided that when X is an alkyl (meth) acrylate, the weight % of Y is other than 0; and wherein the film is prepared by drawing at a temperature below the melting point of the polypropylene at draw ratios of equal to or greater than 3:

2. The oriented film of claim 1 wherein component (b) is present in an amount of from about 1 weight % to about 15 weight %, based on the total weight of the composition.

3. The film of claim 1 wherein X comprises vinyl acetate.

4. The film of claim 1 wherein Y comprises acrylic acid, methacrylic acid, salt of acrylic acid or methacrylic acid, or combinations of two or more thereof.

5. The film of claim 1 wherein Y comprises maleic anhydride, maleic acid, diesters or monoesters of maleic acid, salts of maleic acid or maleic acid monoester, or combinations of two or more thereof.

6. The film of claim 1 wherein said composition further comprises (c) from 0.01 to 40 weight % of at least one additional component selected from the group consisting of fillers, delustrants, UV stabilizers, pigments and other additives.

7. The film of claim 1 being slit to produce a slit film tape.

8. The film of claim 7 wherein the tape is hot-drawn and, optionally, annealed to produce a slit film fiber.

9. The film of claim 8 wherein the slit film fiber is drawn at a draw ratio in the range of about 3:1 to about 16:1.

10. An oriented fiber comprising or prepared from a composition comprising (a) at least one polypropylene polymer and (b) from 0.1 to 15 weight % of at least one E/X/Y copolymer wherein the polypropylene polymer and the E/X/Y copolymer are each as recited in claim 1.

11. The fiber of claim 10 wherein X comprises vinyl acetate.

12. The fiber of claim 10 wherein Y comprises acrylic acid, methacrylic acid, salt of acrylic acid or methacrylic acid, or combinations of two or more thereof.

13. The fiber of claim 10 wherein Y comprises maleic anhydride, maleic diester or monoester, or combinations of two or more thereof.

14. The fiber of claim 10 wherein the composition further comprises (c) from 0.01 to 40 weight % of at least one additional component including fillers, delustrants, UV stabilizers, pigments, or other additives.

15. The fiber of claim 10 that is drawn at a draw ratio in the range of about 3:1 to about 16:1.

16. The oriented fiber of claim 10 that is melt-spun.

17. A process for preparing slit film fiber comprising
(1) preparing a composition as recited in claim 1 wherein the composition optionally comprising (c) from 0.01 to 40 weight % of at least one additional component including fillers, delustrants, UV stabilizers, pigments, or other additives;
(2) forming said composition into a film;
(3) slitting said film into tape;
(4) hot-drawing the tape at a temperature below the melting point of the polypropylene and at a draw ratio equal to or greater than 3, or between 3:1 to 16:1, to produce a drawn tape and, optionally, annealing the drawn tape.

18. A woven, nonwoven, or knitted textile prepared from a fiber wherein the fiber is as recited in claim 10.

19. The woven, nonwoven, or knitted textile of claim 18 wherein the fiber is as produced by the process recited in claim 16.

20. The woven, nonwoven, or knitted textile of claim 18 wherein the fiber is as produced by the process recited in claim 17.
